(19) United States
(12) Patent Application Publication
(10) Pub. No.: US 2008/0091299 A1
(43) Pub. Date: Apr. 17, 2008

(54) WEIGHING AND PACKAGING SYSTEM AND SETTING INPUT DEVICE FOR PRODUCT PROCESSING SYSTEM

(75) Inventors: Takao YOSHIKAWA, Ritto-shi (JP); Hiroe Konishi, Ritto-shi (JP)

Correspondence Address: GLOBAL IP COUNSELORS, LLP, 1233 20TH STREET, NW, SUITE 700, WASHINGTON, DC, 20036-2680, US

(73) Assignee: ISHIDA CO., LTD., Kyoto-shi (JP)

(21) Appl. No.: 11/871,412

(22) Filed: Oct. 12, 2007

(30) Foreign Application Priority Data
Oct. 13, 2006 (JP) JP 2006-279543
Oct. 20, 2006 (JP) JP 2006-285841

(51) Int. Cl. G06F 17/00; G06F 3/048

(52) U.S. Cl. 700/242; 715/771; 715/772

(57) ABSTRACT

A weighing and packaging system includes a weighing unit, a packaging unit, a dropping path, a display unit, a determination unit and a display control unit. The dropping path is disposed between the weighing unit and the packaging unit. The display unit includes a display screen to display an image representing the weighing unit, the dropping path and the packaging unit. The determination unit is configured to determine whether the articles are present in the weighing unit, the dropping path, and the packaging unit, respectively. The display control unit is configured to display an indicator indicative of the articles on the image representing the weighing unit, the dropping path and the packaging unit displayed on the display screen according to a determination result by the determination unit.

### CROSS-REFERENCE TO RELATED APPLICATIONS

This application claims priority to Japanese Patent Application No. 2006-279543, filed on Oct. 13, 2006 and No. 2006-285841, filed on Oct. 20, 2006. The entire disclosures of Japanese Patent Application Nos. 2006-279543 and 2006-285841 are hereby incorporated herein by reference.

### BACKGROUND OF THE INVENTION

1. Field of the Invention

The present invention relates to a weighing and packaging system and a setting input device for a product processing system.

2. Background Information

Japanese Laid-Open Patent Application Publication No. 2005-121512 discloses a combination weighing device in which the operating condition of heads is displayed on a display screen on a real-time basis.

Japanese Laid-Open Patent Application Publication No. 2003-11928 discloses a filling and packaging device in which the packaging conditions are captured by a camera and the activation and deactivation of the device is controlled according to the frequency of occurrence of a failure in the filling and packaging process.

Japanese Laid-Open Utility Model Application Publication No. H06-7024 discloses a timing adjusting device in which empty bags are formed in the preceding and the succeeding of a filled bag and the optimal operation timing is set as an operator visually checks the filling condition.

Japanese Laid-Open Patent Application Publication No. H05-288596 discloses a weighing device in which operating parameters indicative of operating conditions are displayed on an indicator.

Japanese Laid-Open Patent Application Publication No. 2001-287707 discloses a packaging device in which a perspective view of a tray used for packaging is displayed on a screen of an indicator and additionally the setting of the specifications of the tray can be input on the same screen.

In view of the above, it will be apparent to those skilled in the art from this disclosure that there exists a need for an improved weighing and packaging system and an improved setting input device for product processing system. This invention addresses this need in the art as well as other needs, which will become apparent to those skilled in the art from this disclosure.

### SUMMARY OF THE INVENTION

However, with the conventional devices as disclosed in the above mentioned references, the operating conditions can be grasped only on device-by-device basis. Therefore, with a weighing and packaging system in which a weighing unit and a packaging unit are cooperatively operated, it is difficult to set the operation timing of each device since a moving condition of the articles cannot be grasped.

In particular, in case of a vertical pillow-type packaging machine, it is difficult to set the above described operation timing since the processing speed is very high (20-180 bags/minute) and since the positional relationship between sealing jaws that seal the end of the bag and the articles in the bag is difficult to be observed from the outside.

In addition, in case of a combination weighing device, dozens of clusters of articles are collected at high speed every minute as a number of circumferentially arranged hopper gates are opened, and the position of the articles is difficult to be observed from the outside.

In addition, devices constituting a product processing system for weighing, packaging, and the like have various operating parameters. These operating parameters need to be changed or additional such parameters need to be set when an object to be processed changes. When the meanings of these parameters are displayed only by letters (names), it is difficult to grasp the meanings of such parameters since this type of product processing device has a complicated structure. Accordingly, it can be a cause of a setting error.

Therefore, one object of the present invention is to provide a weighing and packaging system in which a moving condition of the target object can be easily grasped and the operation timing of each unit can be easily adjusted based on the moving condition.

Another object of the present invention is to provide a setting input device for a product processing system in which even a novice user who is inexperienced in the operation of the product processing system can perform the setting in an easy and error-proof manner.

A weighing and packaging system according to a first aspect of the invention includes a weighing unit, a packaging unit, a dropping path, a display unit, a determination unit and a display control unit. The weighing unit is configured and arranged to weigh a predetermined amount of articles and to discharge the predetermined amount of the articles to a downstream part. The packaging unit is configured and arranged to package the articles discharged from the weighing unit in a packaging material. The dropping path is disposed between the weighing unit and the packaging unit so that the articles pass through the dripping path from when the articles are discharged from the weighing unit until when the articles are supplied to the packaging unit. The display unit includes a display screen to display an image representing the weighing unit, the dropping path and the packaging unit. The determination unit is configured to determine whether the articles are present in the weighing unit, the dropping path, and the packaging unit, respectively. The display control unit is configured to display an indicator indicative of the articles on the image representing the weighing unit, the dropping path and the packaging unit displayed on the display screen according to a determination result by the determination unit.

According to the first aspect of the present invention, whether or not the articles are present in each of the weighing unit, the dropping path, and the packaging unit can be recognized at a glance by looking at the display screen of the display unit. Thus, it is easy to set opening and closing timing of the gate of the weighing unit, sealing timing of the packaging unit and the like.

The weighing and packaging system according to a second aspect of the invention is preferably arranged such that the weighing unit includes a plurality of weighing hoppers configured and arranged to weigh the articles with each of the weighing hoppers being coupled to a gate that selectively opens and closes a respective one of the weighing hoppers, the packaging unit includes a longitudinal sealing unit configured and arranged to form the packaging material into a cylindrical shape, and a pair of sealing jaws configured and arranged to seal the packaging material formed into the cylindrical shape in a transverse direction, and the dropping path includes a collecting unit configured and arranged to collect the articles that are discharged from the gates of the weighing hoppers and to drop the articles to the packaging unit.

With the weighing and packaging system of the second aspect having the combination weighing device and the vertical pillow-type packaging machine, the effect of the present invention becomes further significant.

The weighing and packaging system according to a third aspect of the invention is preferably arranged such that the display control unit is configured to display the indicator indicative of the articles in a stationary state on the display screen at a predetermined timing.

According to the third aspect, since the articles in a motionless or stationary state are displayed on the display screen, the position of the articles can be easily recognized even when the moving speed of the articles is fast.

The weighing and packaging system according to a fourth aspect of the invention is preferably arranged such that the display control unit is configured to set the predetermined timing to a timing at which the sealing jaws are closed.

According to the fourth aspect, since the positional relationship between the closed sealing jaws and the articles can be grasped, it is more likely to prevent problems such as “jamming” of the articles, “a bag with the articles for two bags” (overweight), “an empty bag” (underweight), and the like.

A setting input device according to a fifth aspect of the invention is a setting input device for a product processing system that performs a predetermined process on a product. The setting input device includes a display unit and a setting input unit. The display unit is configured and arranged to display a first screen including an operating parameter of a device of the product processing system and a first image representing the device. The setting input unit is configured and arranged to receive input for a setting of the operating parameter in a state in which the display unit displays the first screen.

According to the fifth aspect of the present invention, unlike the case where the operating parameter of the device is displayed only by using text, the parameter is displayed with an illustration of the device. Thus, it makes it easy for an operator to understand the meaning of each parameter. Accordingly, even a novice user who is inexperienced in the operation can perform the setting in an easy and error-proof manner.

The setting input device according to a sixth aspect of the invention is preferably arranged such that the display unit is further configured and arranged to display a second screen including specifications required for the product and a second image representing a perspective view of the product.

According to the sixth aspect, settings can be easily performed on one screen not only for the device but also for the product.

The setting input device according to a seventh aspect is preferably arranged such that the display unit is further configured and arranged to display a third screen including a plurality of third images representing perspective views of a plurality of devices, respectively, of the product processing system. Moreover, the setting input unit is configured and arranged to receive a selection of one of the devices according to a selection of one of the third images in a state in which the display unit displays the third screen, and the display unit is further configured and arranged to display the first screen including the first image corresponding to a selected one of the devices upon the selection of the one of the third images being received by the setting input unit.

The seventh aspect of the present invention enables easy selection of a display screen.

The setting input device according to the eighth aspect of the invention is preferably arranged such that the display unit is configured and arranged to display the first screen including the operating parameter related to an operation of a pair of sealing jaws of a vertical pillow-type packaging machine of the product processing system and the first image corresponding to the sealing jaws and a packaging material sandwiched by the sealing jaws.

Since the vertical pillow-type packaging machine includes a longitudinal sealer and a transverse sealer and the operation of the sealing jaws is relatively complicated, it is difficult to have an operator to accurately understand the meaning of the parameter related to the vertical pillow-type packaging machine only by letters. However, according to the present aspect, the use of the illustrations for the setting screen significantly improves the usability.

These and other objects, features, aspects and advantages of the present invention will become apparent to those skilled in the art from the following detailed description, which, taken in conjunction with the annexed drawings, discloses preferred embodiments of the present invention.

### BRIEF DESCRIPTION OF THE DRAWINGS

Referring now to the attached drawings which form a part of this original disclosure:

FIG. 1 is a schematic elevational view of an example of a display screen displayed on a display unit controlled by a central controller of a product processing system according to a first embodiment of the present invention;

FIGS. 2A and 2B are schematic cross-sectional views illustrating a flow of articles in a weighing device and a packaging machine of the product processing system according to the first embodiment of the present invention;

FIGS. 3A and 3B are schematic cross-sectional views illustrating a flow of articles in a weighing device and a packaging machine of the product processing system according to a second embodiment of the present invention.

FIG. 4 is a schematic perspective view the product processing system; in accordance with the first embodiment of the present invention;

FIG. 5 is a schematic elevational diagram showing an example of a combination weighing device of the product processing system according to the first embodiment of the present invention;

FIG. 6 is a schematic perspective view of a vertical pillow-type packaging machine of the product processing system according to the first embodiment of the present invention;

FIG. 7 is a block diagram of a control system of the product processing system according to the first embodiment of the present invention;

FIG. 8 is an elevational view showing an example of an initial screen displayed on a display unit controlled by a central controller according to a third embodiment of the present invention;

FIG. 9 is an elevational view showing an example of a packaging machine setting screen displayed on the display unit controlled by the central controller according to the third embodiment of the present invention;

FIG. 10 is an elevational view showing an example of the packaging machine setting screen with a ten-key window displayed on the display unit controlled by the central controller according to the third embodiment of the present invention;

FIG. 11 is an elevational view showing an example of a inspection device setting screen displayed on the display unit controlled by the central controller according to the third embodiment of the present invention;

FIG. 12 is an elevational view showing an example of the inspection device setting screen with a ten-key window displayed on the display unit controlled by the central controller according to the third embodiment of the present invention;

FIG. 13 is an elevational view showing an example of a product setting screen displayed on the display unit controlled by the central controller according to the third embodiment of the present invention; and

FIG. 14 is an elevational view showing an example of a product setting screen with a ten-key window displayed on the display unit controlled by the central controller according to the third embodiment of the present invention.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

### First Embodiment

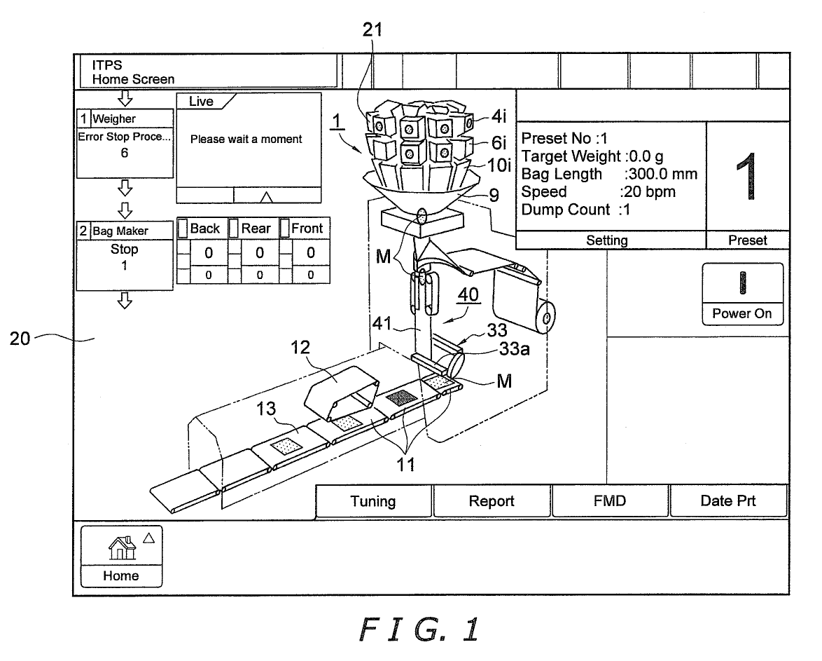

Referring initially to FIGS. 1, 2, and 4 to 7, a product processing system (weighing and packaging system) is illustrated in accordance with a first embodiment of the present invention.

### Overall Configuration of Product Processing System

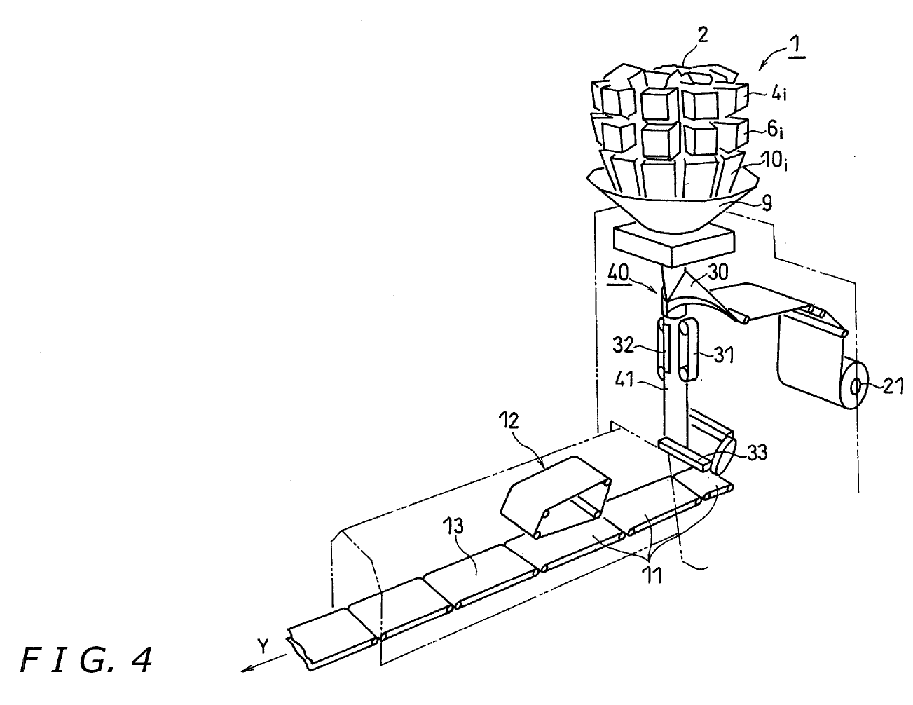

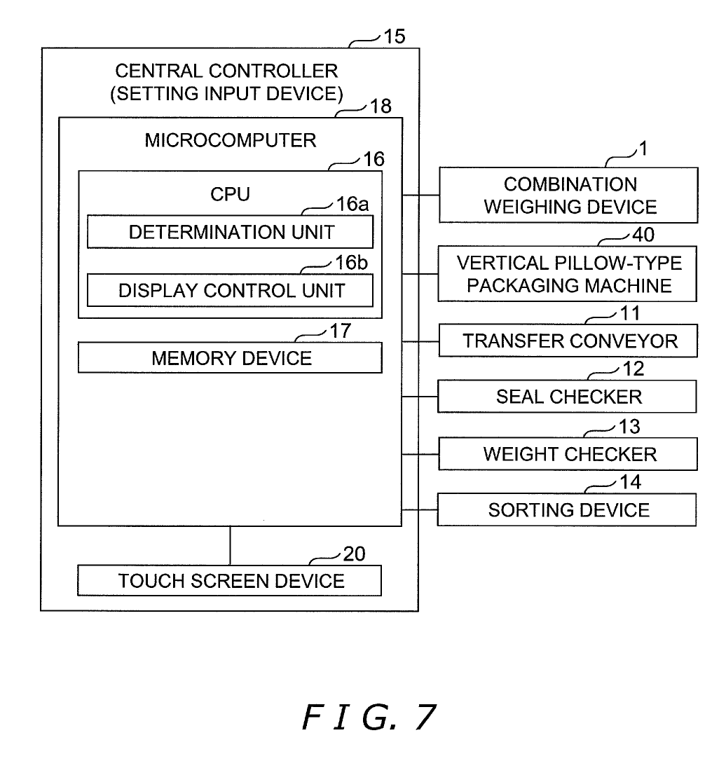

First, an overall configuration of the product processing system of the first embodiment of the present invention will be described. As shown in FIG. 4, the product processing system is a system for manufacturing bagged products and includes a combination weighing device (an example of a weighing unit) 1, a vertical pillow-type packaging machine (an example of a packaging unit) 40, a transfer conveyor 11, a seal checker 12, a weight checker 13, a sorting device 14 (FIG. 7), and the like.

### Combination Weighing Device 1

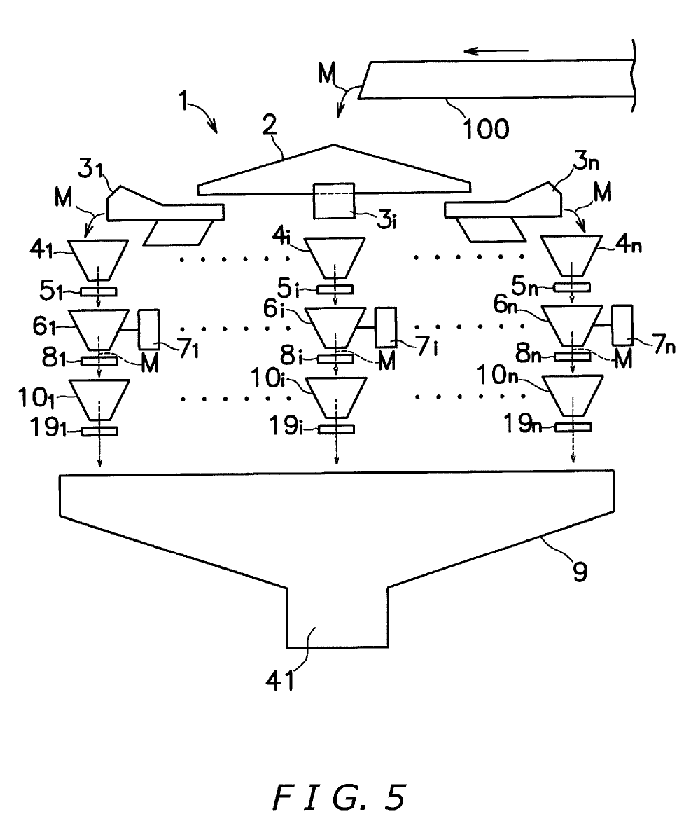

Referring to FIG. 5, the combination weighing device 1 is described below. As shown in FIG. 5, a feeding conveyor 100 drops a target article M (contents) to be weighed to a dispersion unit 2 of the combination weighing device 1. A few of a plurality of articles M are collected together and then bagged as a product.

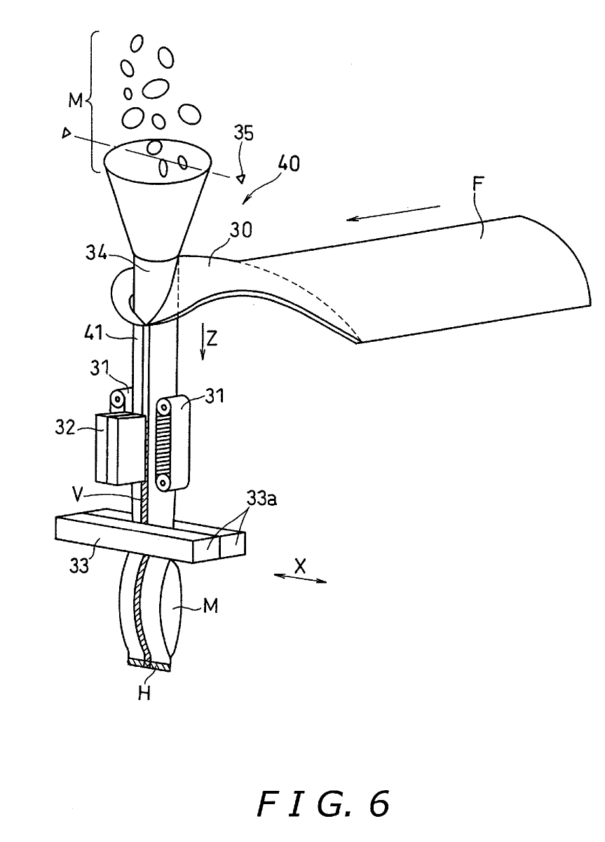

Each of a plurality of supply troughs 3i (i=1, 2, . . . , n) supplies the articles M on the dispersion unit 2 to a corresponding one of a plurality of pool hoppers 4i disposed downstream of the supply troughs 3i. Each of the pool hoppers 4i is provided with a gate 5i, and receives and temporarily holds and stores the articles M supplied by the supply trough 3i. Disposed downstream of each of the pool hoppers 4i is a corresponding one of a plurality of weighing hoppers 6i. Each of the weighing hoppers 6i is disposed with a weighing head including a weight detector 7i for detecting the weight of the articles M fed to the weighing hopper 6i from the pool hopper 4i. Each of the weighing hoppers 6i is also provided with a gate 8i. Disposed below the gate 8i are a corresponding one of a plurality of booster hoppers 10i and a gate 19i. Disposed below the gates 19i is a large collecting discharge chute (collecting unit) 9. The combination weighing device 1 combines the weights of the articles M detected by each of the weight detectors 7i. Therefore, the articles M are collected as a group or combination whose weight or whose quantity is equal to or in a vicinity of a target value, and then the group of the articles M is dropped to a packaging machine 40 shown in FIG. 6.

### Vertical Pillow-Type Packaging Machine 40

The vertical pillow-type packaging machine 40 shown in FIG. 6 includes a tube device 34, a former 30, a pair of pull down belts 31, a longitudinal sealer (an example of a longitudinal sealing unit) 32, an end sealer (transverse sealer) 33, and the like.

With the vertical pillow-type packaging machine 40, a film (an example of a packaging material) F is bent or formed into a cylindrical shape by the former 30. Then, the pull down belts 31 below the former 30 pull the sides of the film F downward. At the same time, the laterally disposed longitudinal sealer 32 seals the end portions (seams) of the film F to each other in its flow direction Z and forms the film F into a cylindrical shape.

The end sealer 33 includes a pair of sealing jaws 33a. As mentioned above, the sheet-like film F is formed into a cylindrical shape as the film F is fitted to the tube device 34, and the overlapped end portions of the film F are sealed to form the longitudinal sealing portion V along its flow direction Z by the longitudinal sealer 32. Then, the cylindrically formed film F is filled with the articles M. Subsequently, the film F is sealed to form the transverse sealing portion H having a strip-shape by the end sealer 33 in a transverse direction X with respect to the flow direction Z of the film F. As a result, a product (the articles M and their package) is produced.

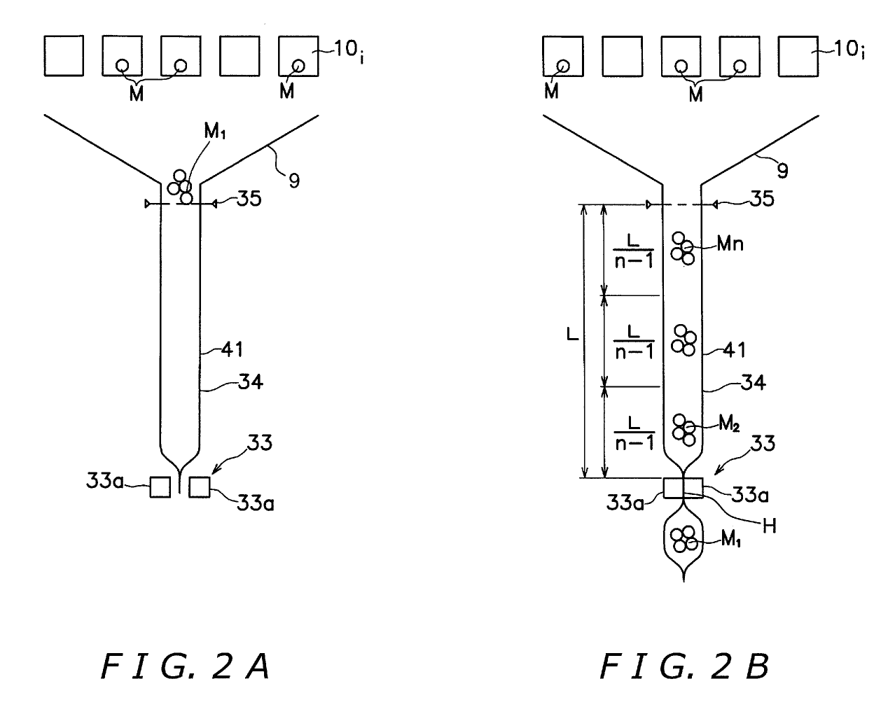

In the first embodiment of the present invention, a drop detector 35 is preferably provided in a top portion of the former 30 as shown in FIG. 5. The drop detector 35 is configured and arranged to detect the articles M discharged from the collecting discharge chute 9 as shown in FIGS. 2A and 2B.

As shown in FIGS. 2A, 2B and 5, the collecting discharge chute 9 and the tube device 34 constitute a dropping path 41 along which the articles M passes through during a period from when the articles M are discharged from the combination weighing device 1 in FIG. 5 until the articles M are supplied to the vertical pillow-type packaging machine 40 and bagged.

### Seal Checker 12

The seal checker 12 shown in FIG. 4 applies pressure to the product M on the transfer conveyor 11 from an upper portion of the product M above and thereby determines whether or not the product M has a faulty seal.

### Weight Checker 13

The weight checker 13 weighs the product M while the product M is being transferred, and thereby determines whether or not the product M is within a predetermined weight range.

### Sorting Device 14

The sorting device 14 shown in FIG. 7 discharges the products M determined to be defective by at least one of the seal checker 12 and the weight checker 13 to the outside of the product processing system. On the other hand, the products M determined to be acceptable are transferred downstream.

### Central Controller 15

The combination weighing device 1, the transfer conveyor 11, the seal checker 12, the weight checker 13, the sorting device 14, and the vertical pillow-type packaging machine 40 shown in FIG. 7 are operatively connected to a central controller (an example of the setting input device) 15 via an interface (not shown). More specifically, each of the combination weighing device 1, the transfer conveyor 11, the seal checker 12, the weight checker 13, the sorting device 14, and the vertical pillow-type packaging machine 40 is preferably provided with a controller that is operatively connected to the central controller 15.

The central controller 15 is configured to control the combination weighing device 1, the transfer conveyor 11, the seal checker 12, the weight checker 13, the sorting device 14, and the vertical pillow-type packaging machine 40 in a centralized or integrated manner. The central controller 15 includes a microcomputer 18 and a touch screen device 20. The microcomputer 18 includes a CPU 16 and a memory device 17.

The memory device 17 is configured to store data corresponding to a plurality of display screens that are displayed on the touch screen device 20 as shown in FIGS. 1 and 8 to 14.

The microcomputer 18 is operatively connected to the touch screen device 20 as shown in FIG. 7.

The touch screen device 20 is configured and arranged to display various screens, for example screens as shown in FIGS. 1 and 8 to 14 based on the instructions received from the central controller 15. The touch screen device 20 is also configured and arranged to allow operators to input operation settings and/or commands by touching onto the displayed screens. Therefore, the touch screen device 20 is a display device and at the same time is an input device for performing predetermined input operations.

The CPU 16 in FIG. 7 includes a determination unit 16a and a display control unit 16b.

The determination unit 16a is configured to determine whether or not the articles M are present in the devices of the product processing device shown in FIG. 4, such as the combination weighing device 1, the dropping path 41, the vertical pillow-type packaging machine 40, the seal checker 12, the weight checker 13, and the like.

According to the determination by the determination unit 16a as to the presence of the articles M, the display control unit 16b is configured to control the display on the touch screen device 20 to display an indicator corresponding to the articles M so as to overlap the images or illustrations of the devices displayed in the display screen on the touch screen device 20.

### Article Display Screen

Referring now to FIG. 1, an article display screen displayed on the touch screen device 20 when the central controller 15 controls the touch screen device 20 in an article display mode will be described. As shown in FIG. 1, the display control unit 16b of the central controller 15 is configured to control the touch screen device 20 to display the article display screen having an image 21 representing to a perspective view of the product processing system of the first embodiment. Of course, it will be apparent to those skilled in the art from this disclosure that the image 21 may illustrate, e.g., a side elevational view of the product processing system, instead of the perspective view.

More specifically, the image 21 on the article display screen displays the devices such as the combination weighing device 1, the vertical pillow-type packaging machine 40, the seal checker 12, the weight checker 13, and the like, which constitute the product processing system.

On the image 21 displayed in the article display screen, indicators corresponding to the articles M in a motionless or stationary state at a predetermined timing (described below) are displayed as shown in FIG. 1 based on the determination results obtained by the determination unit 16a of the central controller 15. For example, when the determination unit 16a determines that the articles M are present in the combination weighing device 1 at a predetermined timing, the indicator corresponding to the articles M is displayed on the image 21 at a position corresponding to the combination weighing device 1. The indicators corresponding to the articles M that are determined to be present in the other devices of the product processing system (e.g., the vertical pillow-type packaging machine 40, the seal checker 12, the weight checker 13, and the like) are also displayed on the image 21 at appropriate positions.

### Method for Determining Presence of Articles and Method for Displaying Articles in Portions Upstream of End Sealer

First, a method for determining whether or not the articles M are present in portions upstream of the end sealer 33, and a method for displaying the indicators corresponding to the articles M on the article display screen displayed on the touch screen device 20 in the portions upstream of the end sealer 33 are described.

Based on various signals regarding each of the devices of the product processing system (e.g., the combination weighing device 1, the transfer conveyor 11, the seal checker 12, the weight checker 13, the sorting device 14, the vertical pillow-type packaging machine 40, and the like) sent from the controller of each of the devices, the determination unit 16a in FIG. 7 is configured to determine whether or not the articles M are present in each of the devices.

For example, whether or not the articles M are present in the pool hopper 4i shown in FIG. 5 is determined based on opening and closing signals of the gate 5i. Whether or not the articles M are present in the weighing hopper 6i is determined based on the change in the weight detected by the weight detector 7i.

Whether or not the articles M are present in the booster hopper 10i in FIG. 4 is determined based on opening and closing signals of the gate 8i corresponding to the weighing hopper 6i and opening and closing signals of the gate 19i corresponding to the booster hopper 10i.

According to the result of the determination by the determination unit 16a as to the presence of the articles M in each of the devices, the display control unit 16b in FIG. 7 is configured to display the indicators corresponding to the articles M on the image 21 at appropriate positions. In other words, the indicators corresponding to the articles M are illustrated at each portion on the image 21 corresponding to each of the devices where it is determined by the determination unit 16a that the articles M are present.

### Method for Determining Presence of Articles in Dropping Path 41

The following method can be used, for example, in order to determine whether or not the articles M are present in the dropping path 41 in FIG. 4.

A period of time elapses after the drop detector 35 detects a first set of articles M₁ as shown in FIG. 2A until the sealing jaws 33a are closed to seal the transverse sealing portion H as shown in FIG. 2B. On the other hand, during this period of time, subsequent sets of the articles M₂, . . . Mₙ are discharged (n−1) times one after another, and the drop detector 35 detects these sets of articles M. Accordingly, the determination unit 16a is configured to determine that (n−1) sets of articles M are present in the dropping path 41 (the tube device 34) between the drop detector 35 and the sealing jaws 33a.

The display control unit 16b is then configured to display the indicators corresponding to these (n−1) sets of the articles M at evenly spaced intervals obtained by dividing a distance L (FIG. 2B) of the dropping path 41 from the drop detector 35 to the sealing jaws 33a by the value (n−1).

### Display Timing

Next, method for determining a display timing when the indicators corresponding to the articles M are displayed on the image 21 displayed on the touch screen device 20 is described according to a case in which timing adjustment is performed, and a case in which an error in cycle occurs.

### When Timing Adjustment is Performed

For example, there is a case where timing adjustment is needed for interlocking operations of the combination weighing device 1 and the vertical pillow-type packaging machine 40 of the product processing system. In such a case, a plurality of the sets of the articles M₁, . . . Mₙ, which are detected by the drop detector 35 during a period from when the drop detector 35 detects the first set of articles M₁ as shown in FIG. 2A until the sealing jaws 33a are closed and the first set of articles M₁ is bagged as show in FIG. 2B, are displayed in a stationary state on the image 21 displayed on the touch screen device 20 in FIG. 1. The sets of the articles M that drop one after another are displayed on the image 21 in a frame-by-frame manner at prescribed timings.

On the image 21 displayed on the touch screen device 20, the sealing jaws 33a, the indicators corresponding to the sets of the articles M in the dropping path 41 at the time when the sealing jaws 33a are closed as shown in FIG. 2B and the indicators corresponding to the articles M in the hoppers 4i, 6i, and 10i are displayed in a motionless or stationary state as shown in FIG. 1.

Since the positional relationship between the closed sealing jaws 33a and the articles M can be grasped and observed by the operator on the touch screen device 20, the operator can adjust the closing timing of the sealing jaws 33a to prevent problems such as jamming of the articles M, producing an overfilled bag (e.g., a bag filled with an amount of the articles M for two bags), producing an empty bag, and the like. Further, even when the moving speed of the articles M is fast, the position of the articles M can be easily recognized since the indicators corresponding to the articles M are displayed on the touch screen device 20 in a motionless, stationary state.

If it is determined that the first bag is an empty bag as a result of actually visually checking the product M manufactured by the vertical pillow-type packaging machine 40, the operator delays the closing timing of the sealing jaws 33a. On the other hand, when a bag filled with an amount of the articles M for two bags is produced, the operator accelerates the closing timing of the sealing jaws 33a. When jamming occurs, the closing timing of the sealing jaws 33a is adjusted to be slightly accelerated or slightly delayed.

When the number of the indicators corresponding to the sets of the articles M displayed on the image 21 on the touch screen device 20 is not consistent with the number of actually packaged bags, it is highly possible that the operator made an error in setting the operation timing of the product process system. In this way, the image 21 displayed on the touch screen device 20 can be used as a guide as the operator sets the operation timing.

### When Error in Cycle Occurs

On the other hand, there is a case where a combination within a predetermined weight range cannot be obtained during the operation of the combination weighing device 1. In such a case, the articles M are supplied to the weighing hopper 6i but the articles M are not discharged from the weighing hopper 6i and the sealing operation of the transverse sealing portion H by the sealing jaws 33a is not performed until a combination within a predetermined weight range is obtained. In other words, the sealing jaws 33a are momentarily stopped during the operation of the product processing system. In such a case, with a conventional product processing system, the operator may easily feel anxiety wondering if the vertical pillow-type packaging machine 40 broke down.

However, with the product processing system of the present invention, the indicators corresponding to the articles M are displayed on the image 21. Accordingly, when a combination within a predetermined weight range cannot be obtained, the operator can immediately know the reason why the sealing jaws 33a did not perform the transverse sealing operation.

Therefore, since the operating conditions of the combination weighing device 1 and the vertical pillow-type packaging machine 40 can be immediately observed, it is possible to eliminate the operator's anxiety and the like.

### Method for Determining Presence of Articles and Method for Displaying Articles in Portions Downstream of End Sealer

Next, a method for determining whether or not the articles M are present in the devices downstream of the end sealer 33 (e.g., the transfer conveyor 11, the seal checker 12, the weight checker 13, the sorting device 14 and the like), and a method for displaying the indicators corresponding to the articles M in the image 21 at positions corresponding to such devices downstream of the end sealer 33 are described.

Based on the number of the products M (the number of the sets of the articles M), which are bagged as the sealing jaws 33a are closed, and the transfer speed of the transfer conveyor 11, the determination unit 16a (FIG. 7) is configured to determine whether or not the product M is present on the transfer conveyor 11 and to specify the position of the product M. Based on the result of the determination by the determination unit 16a as to the presence of the articles M and the information regarding the position thereof, the display control unit 16b in FIG. 7 is configured to display the indicators corresponding to the articles M on the image 21 displayed on the touch screen device 21 as shown in FIG. 1.

In the first embodiment of the present invention, the indicator corresponding to the product M determined to be defective by the seal checker 12 and the weight checker 13 is preferably displayed in a different color than the indicators corresponding to other non-defective products.

According to the first embodiment of the present invention, whether or not the articles are present in each of the weighing unit (the combination weighing device 1), the dropping path 41, and the packaging unit (the vertical pillow-type packaging machine 40) can be recognized by the operator at a glance of the display unit (the touch screen device 20), and thus, it is easy to set operation timings of the product processing system such as opening and closing timing of the gates of the weighing unit, sealing timing of the packaging unit and the like.

### Second Embodiment

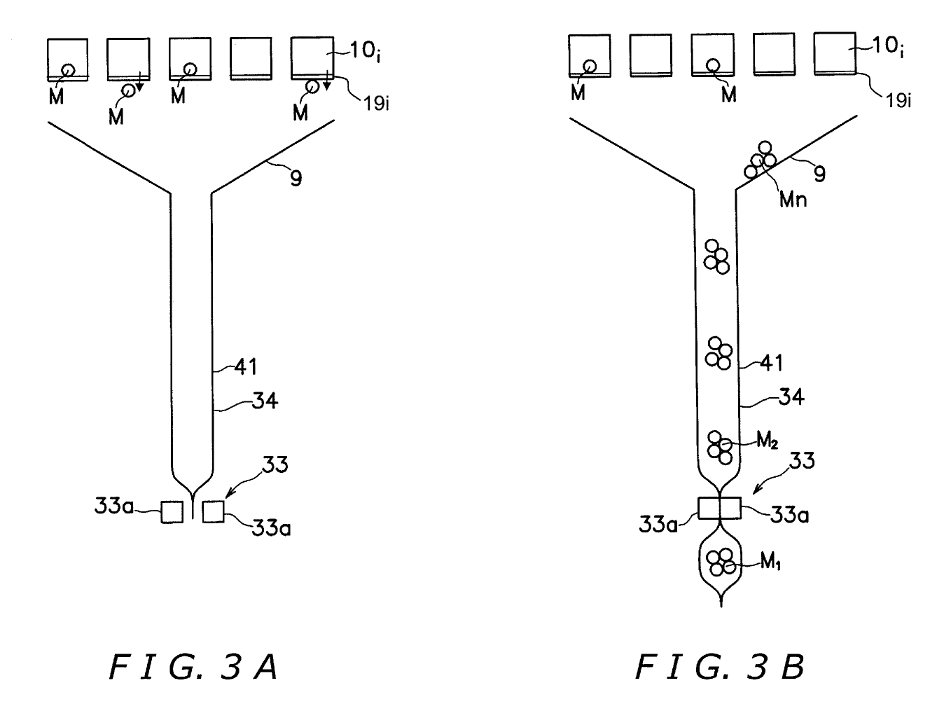

Referring now to FIGS. 3A and 3B, the product processing system in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity.

The product processing system of the second embodiment differs from the product processing system of the first embodiment in that the drop detector 35 of the first embodiment is not provided in the dropping path 41 in the second embodiment. More specifically, in the second embodiment, the determination unit 16a (FIG. 7) is configured to determine whether or not the articles M are present in the dropping path 41 including the collecting discharge chute 9 and the tube device 34 (FIG. 6) based on discharge signals to open the gates 19i corresponding to the booster hoppers 10i shown in FIG. 5.

A period of time elapses between timing at which the first discharge signal is sent to the gate 19i corresponding to the booster hopper 10i (FIG. 5) and the gate 19i is opened and closed as shown in FIG. 3A and timing at which the sealing jaws 33a are closed to perform the sealing operation of the transverse sealing portion H as shown in FIG. 3B. On the other hand, during this period of time, n sets of articles M drop in the dropping path 41. The discharge signal to discharge the articles M from the booster hoppers 10i is sent from the controller of the combination weighing device 1 shown in FIG. 7 to the central controller 15 every time the articles M are dropped. Accordingly, based on the discharge signals, the determination unit 16a is configured to determine that (n−1) sets of the articles M are present in the dropping path 41 between the booster hoppers 10i and the sealing jaws 33a as shown in FIG. 3B.

Therefore, the display control unit 16b is configured to display the indicators corresponding to the sets of the articles M in the dropping path 41 on the image 21 at positions at evenly spaced intervals obtained by dividing the distance of dropping path 41 by the value (n−1).

The other configurations of the product processing system of the second embodiment are the same as those of the first embodiment illustrated in FIGS. 1 and 4 to 7. The same portions or the corresponding portions are denoted by the same reference symbols and the descriptions thereof are omitted.

In the first and second embodiments of the present invention described above the indicators corresponding to the articles M and the products M are displayed in a stationary manner. Alternatively, the articles M and the product M may be displayed on the image 21 on a real-time basis.

In addition, the indicators indicative of the product M with a printing error and a jamming error which occur in the vertical pillow-type packaging machine 40, the overweight product and the product M with a weighing error which occur in the combination weighing device 1, and the like may be displayed on the image 21 in a color coded manner.

Furthermore, by using the information regarding the product M displayed on the image 21 displayed on the touch screen device 20, the product processing system may be configured such that the interlock timing of each device can be automatically adjusted after the general device setting is performed.

In addition, a packaging machine which introduces the articles M one after another into a plurality of packaging materials formed in a bag shape while rotating these bags in a generally horizontal direction may be used as a packaging machine of the product processing system instead of the vertical pillow-type packaging machine 40.

In addition, the average drop speeds in which various types of articles drop in the dropping path 41 may be stored in the memory device 17 in advance. The product processing system may be configured such that when the operator specifies the type of the articles that is the most similar to the articles M to be processed, the CPU 16 reads out of the memory device 17 the drop speed corresponding to the specified the type of the articles and calculates the position of the articles M in the dropping path 41 based on the drop speed. The display control unit 16b may display the indicators corresponding to the articles M at positions corresponding to the position of the articles M in the dropping path 41 on the image 21 displayed on the touch screen device 20.

### Third Embodiment

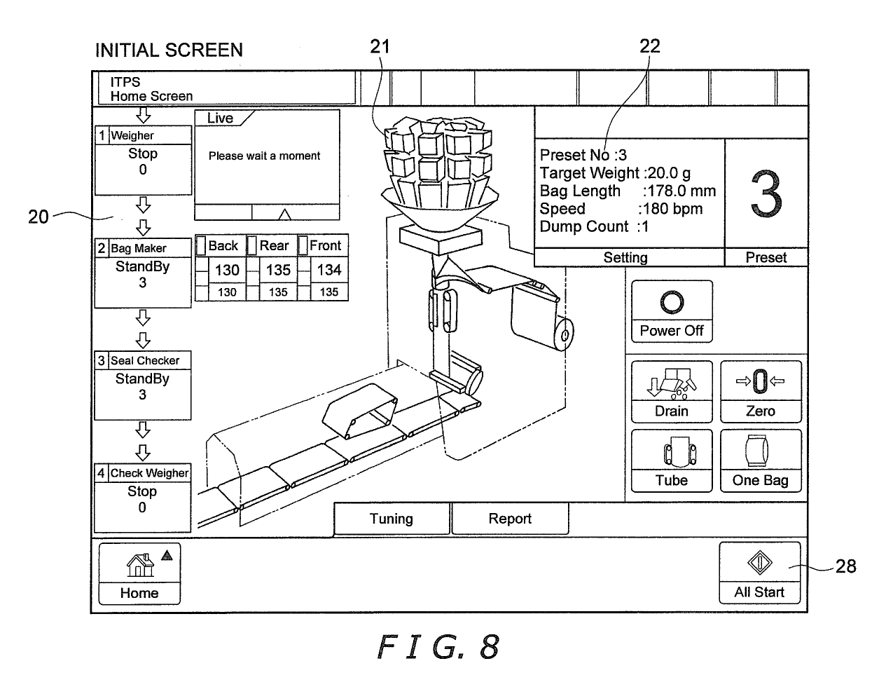

Referring now to FIGS. 8 to 14, a product processing system in accordance with a third embodiment will now be explained. In view of the similarity between the first and third embodiments, the parts of the third embodiment that are identical to the parts of the first embodiment will be given the same reference numerals as the parts of the first embodiment. Moreover, the descriptions of the parts of the third embodiment that are identical to the parts of the first embodiment may be omitted for the sake of brevity.

The structures of the product processing system of the third embodiment are basically identical to the structures of the product processing system illustrated in FIGS. 4 to 7. The third embodiment differs from the first embodiment in that several different display screens are displayed on the touch screen device 20 for setting operating parameters when the product processing system are in a parameter setting mode.

The controller of each of the combination weighing device 1, the transfer conveyor 11, the seal checker 12, the weight checker 13, the sorting device 14, and the vertical pillow-type packaging machine 40 is configured and arranged to store operating parameters to operate the corresponding devices, and to control the corresponding devices based on these operating parameters.

In the third embodiment, the CPU 16 of the central controller 15 is configured to control the product processing system in one of an operation mode and an operating parameter setting mode. In the operation mode, the combination weighing device 1, the transfer conveyor 11, the seal checker 12, the weight checker 13, the sorting device 14, and the vertical pillow-type packaging machine 40 are operated in an interlocked manner. In the operating parameter setting mode, operating parameters are sent to the controllers of the combination weighing device 1, the transfer conveyor 11, the seal checker 12, the weight checker 13, the sorting device 14, and the vertical pillow-type packaging machine 40 and thereby the operating parameters of the combination weighing device 1, the transfer conveyor 11, the seal checker 12, the weight checker 13, the sorting device 14, and the vertical pillow-type packaging machine 40 are set.

### Operation Mode

When the operator performs predetermined operations on the product processing system (e.g., weighing and packaging operation of the articles M), the display control unit 16b of the central controller 15 is configured to display an initial screen on the touch screen device 20 as shown in FIG. 8. As shown in FIG. 8, the initial screen displays the image or illustration 21 that represents a perspective view of the product processing system of the third embodiment. Moreover, the initial screen displayed on the touch screen device 20 includes a setting screen display button 22, a start button 28, and the like as shown in FIG. 8.

When the operator touches the start button 28 in the initial screed displayed on the touch screen device 20, the CPU 16 is configured to set the product processing system in the operation mode. Then, the combination weighing device 1, the transfer conveyor 11, the seal checker 12, the weight checker 13, the sorting device 14, and the vertical pillow-type packaging machine 40 are configured to read out the operating parameters from the respective controllers connected to the respective devices (the combination weighing device 1, the transfer conveyor 11, the seal checker 12, the weight checker 13, the sorting device 14, and the vertical pillow-type packaging machine 40) and to produce the product (the articles packaged in a packaging material) based on these operating parameters.

### Operating Parameter Setting Mode

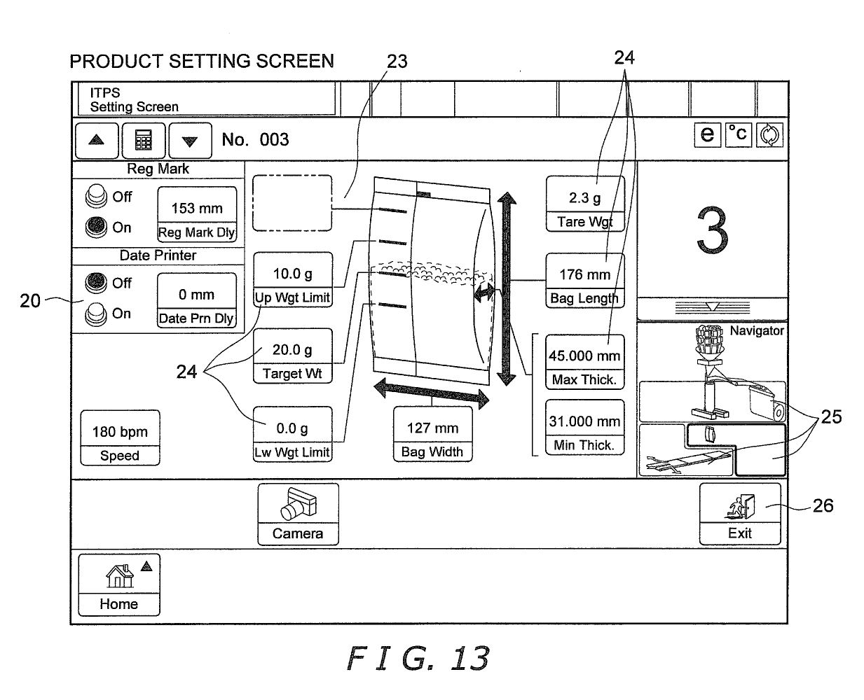

On the other hand, when it is desired to change the operating parameters of the combination weighing device 1, the transfer conveyor 11, the seal checker 12, the weight checker 13, the sorting device 14, and/or the vertical pillow-type packaging machine 40, the operator touches the setting screen display button 22 in the initial screen displayed on the touch screen device 20 as shown in FIG. 8. Consequently, the CPU 16 is configured to set the product processing system in the operating parameter setting mode. Then, the display control unit 16b of the CPU 16 is configured to display a product setting screen shown in FIG. 13 on the touch screen device 20.

The product setting screen displays an image 23 representing a perspective view of the product, a plurality of setting buttons 24, a plurality of device selection buttons 25, an exit button 26, and the like as shown in FIG. 13. On each of the device selection buttons 25, an icon representing a perspective view of the corresponding device and/or the product is displayed.

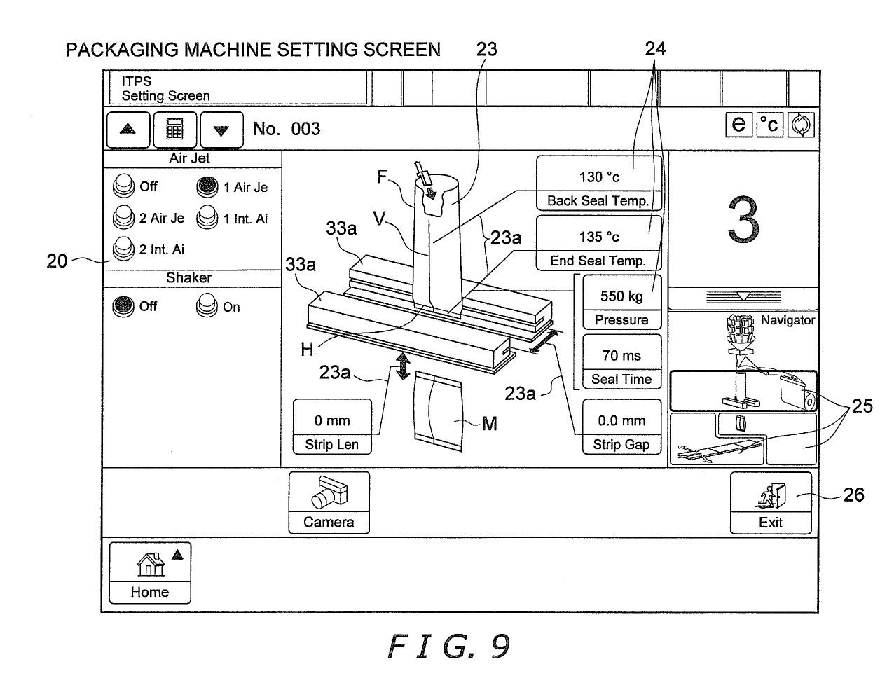

For example, in case of inputting the setting (values) of the operating parameters of the vertical pillow-type packaging machine 40 (FIG. 6), the operator touches the device selection button 25 that corresponds to the vertical pillow-type packaging machine 40, and thereby a packaging machine setting screen shown in FIG. 9 is displayed.

### Packaging Machine Setting Screen

As shown in FIG. 9, the packaging machine setting screen displays an image 23 corresponding to a perspective view of the vertical pillow-type packaging machine 40, the setting buttons 24, the device selection buttons 25, the exit button 26, and the like.

On the image 23, the film F, the sealing jaws 33a, a longitudinal seal V portion, a transverse seal H portion, the product M, and the like are illustrated.

On the setting buttons 24, all the operating parameters needed for the operation of the vertical pillow-type packaging machine 40 (FIG. 6) are displayed by text including, for example, longitudinal sealing temperature, transverse sealing temperature, transverse sealing pressure, period of time for transverse sealing, gap between the sealing jaws 33a and 33a at the time of transverse sealing, and declining length of the sealing jaws 33a.

A leader line 23a is displayed between each setting button 24 and the portion of the image 23 corresponding to the setting button 24.

For example, the leader line 23a is drawn from the setting button 24 corresponding to the longitudinal sealing temperature to the longitudinal seal portion V of the film F on the image 23.

In addition, the leader lines 23a are drawn from the setting buttons 24 corresponding to the transverse seal temperature, the transverse sealing pressure, and the period of time for transverse sealing to the transverse seal portion H of the film F on the image 23.

Furthermore, the leader line 23a is drawn from the setting button 24 corresponding to the gap between the sealing jaws 33a and 33a at the time of transverse sealing to an arrow displayed in the gap between the sealing jaws 33a and 33a on the image 23.

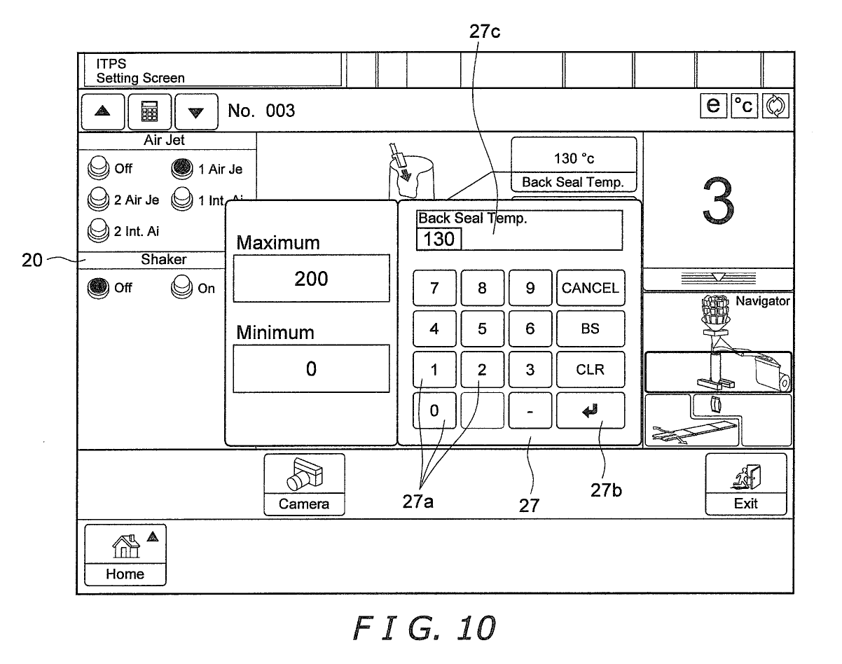

In addition, the leader line 23a is drawn from the setting button 24 corresponding to the declining length of the sealing jaws 33a at the time of transverse sealing to an arrow displayed below the sealing jaws 33a on the image 23. When the operator touches one of the setting buttons 24 for inputting the setting of operating parameters, a ten-key window 27 is displayed as shown in FIG. 10. The ten-key window 27 displays a plurality of number buttons 27a, a return button 27b, and a display window 27c for an input value. Thus, the central controller 15 is configured and arranged to receive input for a setting of the operating parameter in a state in which the touch screen device 20 displays the packaging machine setting screen.

When the operator touches the return button 27b after inputting a predetermined numerical value by touching the number buttons 27a, the packaging machine setting screen shown in FIG. 9 is displayed again. The input value is displayed on the corresponding setting button 24 on the packaging machine setting screen. For example, FIG. 9 shows an example in which the input value is displayed on an upper portion of the corresponding setting button 24.

The operator touches the various setting buttons 24 and repeats inputting the setting of the operating parameters for the vertical pillow-type packaging machine 40 as desired.

After inputting the setting of the operating parameters, when the operator touches the exit button 26, the CPU 16 in FIG. 7 is first configured to send the operating parameters displayed on the setting buttons 24 to the controller of the vertical pillow-type packaging machine 40. Then, the CPU 16 is configured to complete the operating parameter setting mode, and then to display the initial screen shown in FIG. 8 on the touch screen device 20.

Upon receiving the operating parameters from the central controller 15, the controller of the vertical pillow-type packaging machine 40 in FIG. 7 is configured to store (overwrite) these input operating parameters as the new operating parameters.

As described above, the image 23 representing the perspective view of the device is displayed on the corresponding device setting screen and the leader lines 23a are drawn from the image 23 to the setting buttons 24 on which the operating parameters are displayed. Thereby, the relationship between each portion of the image 23 and each operating parameter is clearly expressed. Therefore, unlike the case where the operating parameters of the device are displayed only by text, it is easy for the operator to understand the meaning of each parameter, and thus even a novice user who is inexperienced in the operation can perform the setting in an easy and error-proof manner.

In particular, the vertical pillow-type packaging machine 40 (FIG. 6) includes a longitudinal sealer and a transverse sealer, and the operation of the sealing jaws 33a is relatively complicated. Thus, it is difficult to have the operator to accurately understand the meaning of the parameters related to the vertical pillow-type packaging machine 40 only by displaying the parameters using text. However, according to the product processing system of the third embodiment, the usability is significantly improved by showing the vertical pillow-type packaging machine 40 in the image 23 displayed on the touch screen device 20.

When inputting the setting of the operating parameters of the device is completed, the operator touches the exit button 26 to return to the initial screen shown in FIG. 8. Subsequently, when the operator performs a predetermined operation on the touch screen device 20, the CPU 16 is set to the operation mode and the system is operated.

### Inspection Device Setting Screen

On the other hand, in case of further inputting the setting of an operating parameter of a different device after the setting of the operating parameters of the vertical pillow-type packaging machine 40 is performed on the packaging machine setting screen in FIG. 9, the operator touches the device selection button 25 on which a perspective view of the different device is displayed.

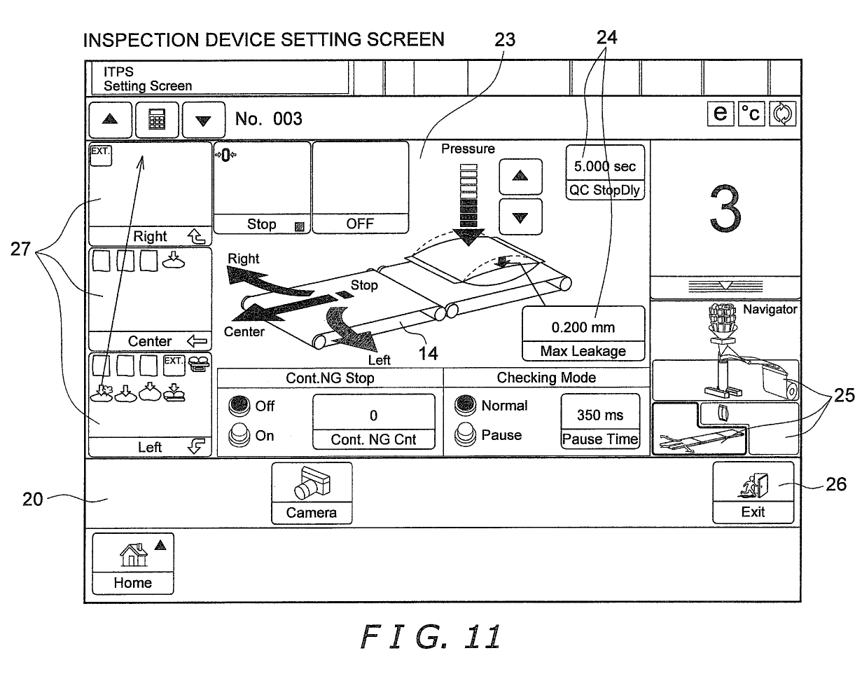

For example, when the operator touches the device selection button 25 corresponding to the seal checker 12, an inspection device setting screen shown in FIG. 11 is displayed on the touch screen device 20. On the setting buttons 24, all the operating parameters needed for the operation of the seal checker 12 are displayed.

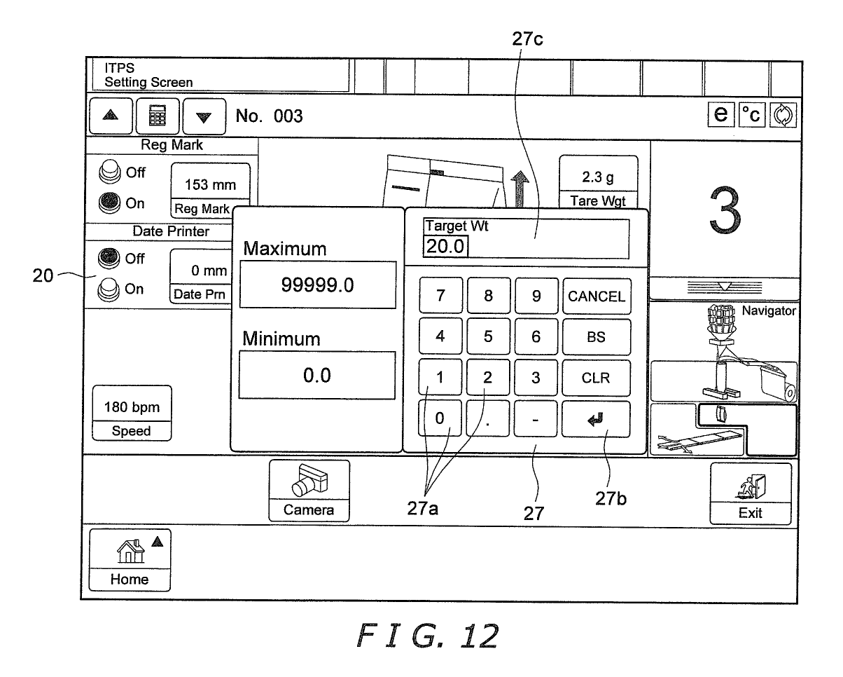

The operator touches the setting button 24 for input setting in order to display the ten-key window 27 shown in FIG. 12, and inputs the setting of the operating parameters of the seal checker 12. After inputting the setting for the operating parameters, when the operator touches the exit button 26, the operating parameters are sent to the controller of the seal checker 12 and stored (overwritten) as the new operating parameters. Thus, the central controller 15 is configured and arranged to receive input for a setting of the operating parameter in a state in which the touch screen device 20 displays the inspection device setting screen.

As described above, when the operator touches one of the device selection buttons 25, which are disposed on the display screen and on which perspective views of a plurality of devices are illustrated, a different display screen corresponding to the touched device selection button is displayed on the touch screen device 20, enabling easy screen selection.

### Product Setting Screen

When inputting the setting of operating parameters of each device for the product M, the operator touches the device selection button 25 on which a perspective view of the product M is illustrated in order to display the product setting screen shown in FIG. 13 on the touch screen device 20.

As mentioned earlier, the product setting screen displays the image 23 representing the perspective view of the product M, the setting buttons 24, the device selection buttons 25, the exit button 26, and the like.

The setting buttons 24 include buttons for, for example, length, width, and thickness of a bag of the product M, tare weight, target weight of the articles, and maximum and minimum weights of the articles. Each setting button 24 is connected to the corresponding portion of the product M displayed on the image 23 by the leader line 23a.

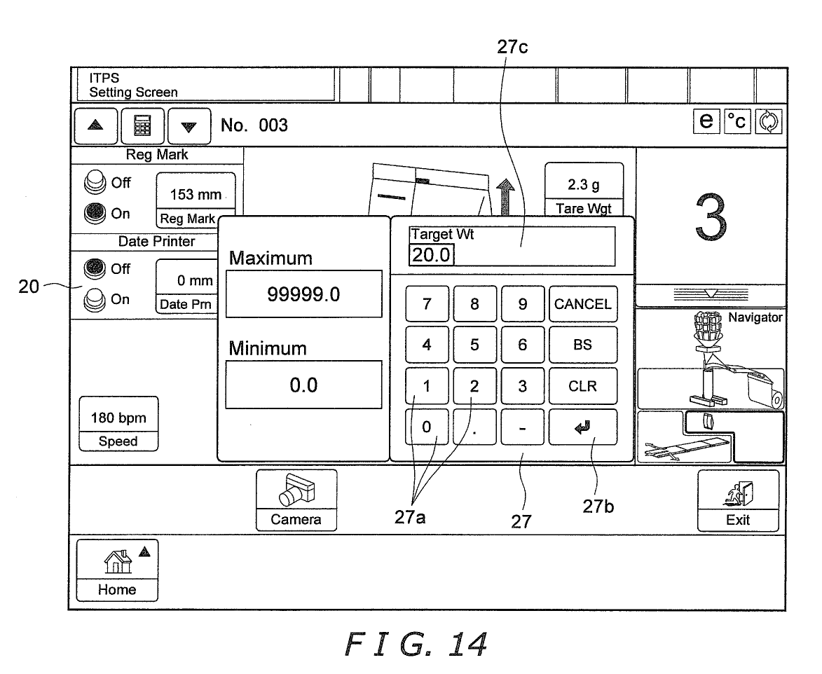

The operator touches the setting button 24 in order to display the ten-key window 27 shown in FIG. 14, and inputs the setting of operating parameters. Thus, the central controller 15 is configured and arranged to receive input for a setting of the operating parameter in a state in which the touch screen device 20 displays the product setting screen. After inputting the setting, when the exit button 26 is touched, these operating parameters are sent to the controllers of the devices corresponding to these operating parameters and stored (overwritten) as the new operating parameters.

For example, operating parameters such as length, width, and thickness of a bag of the product M, tare weight and the like are sent to the controller of the vertical pillow-type packaging machine 40. On the other hand, operating parameters such as target weight of the articles, maximum and minimum weights of the articles and the like are sent to the controllers of the combination weighing device 1 and the weight checker 13.

As described above, disposition of the product setting screen enables the setting of operating parameters of various devices to be input on one screen not only for the devices but also for the product and thus the convenience is improved.

As shown in FIG. 11, the inspection device setting screen displays not only the image 23 representing the perspective view of the sorting device 14 but also a sorting display fields 27. The sorting display fields 27 include a right sorting field, a non-sorting field, and a left sorting field. Each display field displays an illustration (icon) showing a condition of the product M to be sorted. An operating parameter of the sorting device 14 can be set by moving the icon to be sorted to the display field corresponding to the sorting direction.

For example, when sorting the product M having a faulty seal to the right, an icon corresponding to a faulty seal is moved to the right sorting field as shown by an arrow in FIG. 11, and thereby such setting will be stored (overwritten) as the new operating parameter in the controller of the sorting device 14.

In addition, although the touch screen device 20 is described as an example of the display and input device in the first to the third embodiments, the system may be equipped with a display device including an LCD or a CRT (Cathode Ray Tube) display and an input device such as a mouse and/or a keyboard.

Furthermore, in the third embodiment, the system may be equipped with a help function to display the articles of each operating parameter displayed on the setting button 24 in writing and illustrations. In this way, it is possible to know detailed information regarding each operating parameter by using the help function.

In addition, in the first to the third embodiments, acceleration is facilitated when the booster hopper 10i is disposed below each weighing hopper 6i. However, the booster hopper 10i does not necessarily need to be provided in the combination weighing device 1. In addition, as the combination weighing device 1, a device disposed with timing hoppers may be used. Such timing hoppers may be disposed in a plurality of stages above and below.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. The term “detect” as used herein to describe an operation or function carried out by a component, a section, a device or the like includes a component, a section, a device or the like that does not require physical detection, but rather includes determining, measuring, modeling, predicting or computing or the like to carry out the operation or function. The term “configured” as used herein to describe a component, section or part of a device includes hardware and/or software that is constructed and/or programmed to carry out the desired function. The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A weighing and packaging system comprising:
a weighing unit configured and arranged to weigh a predetermined amount of articles and to discharge the predetermined amount of the articles to a downstream part;
a packaging unit configured and arranged to package the articles discharged from the weighing unit in a packaging material;
a dropping path disposed between the weighing unit and the packaging unit so that the articles pass through the dripping path from when the articles are discharged from the weighing unit until when the articles are supplied to the packaging unit;
a display unit including a display screen to display an image representing the weighing unit, the dropping path and the packaging unit;
a determination unit configured to determine whether the articles are present in the weighing unit, the dropping path, and the packaging unit, respectively; and
a display control unit configured to display an indicator indicative of the articles on the image representing the weighing unit, the dropping path and the packaging unit displayed on the display screen according to a determination result by the determination unit.

2. The weighing and packaging system according to claim 1, wherein
the weighing unit includes a plurality of weighing hoppers configured and arranged to weigh the articles with each of the weighing hoppers being coupled to a gate that selectively opens and closes a respective one of the weighing hoppers,
the packaging unit includes a longitudinal sealing unit configured and arranged to form the packaging material into a cylindrical shape, and a pair of sealing jaws configured and arranged to seal the packaging material formed into the cylindrical shape in a transverse direction, and
the dropping path includes a collecting unit configured and arranged to collect the articles that are discharged from the gates of the weighing hoppers and to drop the articles to the packaging unit.

3. The weighing and packaging system according to claim 2, wherein
the display control unit is configured to display the indicator indicative of the articles in a stationary state on the display screen at a predetermined timing.

4. The weighing and packaging system according to claim 3, wherein
the display control unit is configured to set the predetermined timing to a timing at which the sealing jaws are closed.

5. A setting input device for a product processing system that performs a predetermined process on a product, the setting input device comprising:
a display unit configured and arranged to display a first screen including an operating parameter of a device of the product processing system and a first image representing the device; and
a setting input unit configured and arranged to receive input for a setting of the operating parameter in a state in which the display unit displays the first screen.

6. The setting input device according to claim 5, wherein
the display unit is configured and arranged to display the first screen including the first image that represents a perspective view of the device of the product processing system.

7. The setting input device according to claim 5, wherein
the display unit is further configured and arranged to display a second screen including specifications required for the product and a second image representing a perspective view of the product.

8. The setting input device according to claim 5 wherein
the display unit is further configured and arranged to display a third screen including a plurality of third images representing perspective views of a plurality of devices, respectively, of the product processing system,
the setting input unit is further configured and arranged to receive a selection of one of the devices according to a selection of one of the third images in a state in which the display unit displays the third screen, and
the display unit is further configured and arranged to display the first screen including the first image corresponding to a selected one of the devices upon the selection of the one of the third images being received by the setting input unit.

9. The setting input device according to claim 5, wherein
the display unit is configured and arranged to display the first screen including the operating parameter related to an operation of a pair of sealing jaws of a vertical pillow-type packaging machine of the product processing system and the first image corresponding to the sealing jaws and a packaging material sandwiched by the sealing jaws.

10. The setting input device according to claim 7, wherein
the display unit is configured and arranged to display the first screen including the operating parameter related to an operation of a pair of sealing jaws of a vertical pillow-type packaging machine of the product processing system and the first image corresponding to the sealing jaws and a packaging material sandwiched by the sealing jaws.

11. The setting input device according to claim 8, wherein
the display unit is configured and arranged to display the first screen including the operating parameter related to an operation of a pair of sealing jaws of a vertical pillow-type packaging machine of the product processing system and the first image corresponding to the sealing jaws and a packaging material sandwiched by the sealing jaws.
